(19) United States
(12) Patent Application Publication
(10) Pub. No.: US 2022/0174071 A1
(43) Pub. Date: Jun. 2, 2022

(54) INFORMATION PROCESSING DEVICE AND CONTROL METHOD

(71) Applicant: SHARP KABUSHIKI KAISHA, Sakai City (JP)

(72) Inventor: Tatsuya WATABE, Sakai City (JP)

(21) Appl. No.: 17/529,877

(22) Filed: Nov. 18, 2021

(30) Foreign Application Priority Data
Nov. 30, 2020 (JP) 2020-198698

(51) Int. Cl. H04N 1/44

(52) U.S. Cl. CPC H04L 63/108; H04N 1/4433

(57) ABSTRACT

An information processing device includes a memory and a controller. The memory stores, in an associated manner, information on a connection source and a time when denial of a connection request from the connection source is to be lifted. The controller, upon receiving a connection request from the connection source, denies the connection request based on the information stored in the memory. The controller removes the information on the connection source from the memory when the time has passed.

### CROSS-REFERENCE TO RELATED APPLICATION

The present application claims priority from Japanese Patent Application Number 2020-198698, the content of which is hereby incorporated by reference into this application.

### BACKGROUND OF THE INVENTION

### 1. Field of the Invention

The present disclosure relates to, for example, information processing devices.

### 2. Description of the Related Art

Systems and devices have been used that detect an illegal connection request that comes from a device connected to the network to prohibit accesses from the device that has sent in the connection request.

For instance, techniques are proposed that determine that a monitored flow is being subjected to, for example, an Http Get Flooding attack if burst state where the monitored flow has a packet interval shorter than or equal to a particular length of time continues for an uninterrupted period of time that exceeds a prescribed threshold (see, for example, Japanese Unexamined Patent Application Publication, Tokukai, No. 2017-147558).

### SUMMARY OF THE INVENTION

An illegal connection request is detected typically on the basis of whether or not the device that has sent in a connection request has an IP (Internet Protocol) address that is deemed illegal.

The attacker who has sent in the illegal connection request will likely to spoof IP addresses or control a large number of PCs (personal computers) to mount an attack using many IP addresses.

Meanwhile, there are approximately 4.3 billion IPv4 IP addresses. If all the IP addresses of possible illegal access originators (devices transmitting illegal connection requests) are stored as prohibited addresses, huge memory is consumed in the device that receives the connection requests. It also takes time to collate the IP addresses of the devices that have sent in the connection requests to see whether these IP addresses are illegal or not. It is therefore necessary to focus on those possible illegal access originators that can be particularly risky or annoying and only store information on these possible illegal access originators. Japanese Unexamined Patent Application Publication, Tokukai, No. 2017-147558 is silent about this concept.

The present disclosure, in view of these issues, has an object to provide, for example, an information processing device capable of appropriately storing information on connection sources for which connection requests are denied.

To address the issues, the present disclosure is directed to an information processing device including: a memory that stores, in an associated manner, information on a connection source and a time when denial of a connection request from the connection source is to be lifted; and a controller that, upon receiving a connection request from the connection source, denies the connection request based on the information stored in the memory, wherein the controller removes the information on the connection source from the memory when the time has passed.

The present disclosure is also directed to a control method including: the storing step of storing, in an associated manner, information on a connection source and a time when denial of a connection request from the connection source is to be lifted; the denial step of, upon receiving a connection request from the connection source, denying the connection request based on the information stored in the storing step; and the removal step of removing the information on the connection source when the time has passed.

The present disclosure enables appropriate storing of information on connection sources for which connection requests are denied.

### BRIEF DESCRIPTION OF THE DRAWINGS

FIG. 1 is a perspective view of the exterior of an image forming apparatus in accordance with a first embodiment.

FIG. 2 is a diagram showing a functional configuration of the image forming apparatus in accordance with the first embodiment.

FIG. 3 is a diagram showing a data structure of a prohibition list in accordance with the first embodiment.

FIG. 4 is a diagram showing a flow of a connection process in accordance with the first embodiment.

FIG. 5 is a diagram showing a flow of a prohibition list managing process in accordance with the first embodiment.

FIG. 6 is a diagram showing a flow of a prohibition list managing process in accordance with the first embodiment.

FIG. 7 is a diagram showing a functional configuration of an image forming apparatus in accordance with a second embodiment.

FIGS. 8A-8B are a set of diagrams each showing a data structure of a detection conditions list in accordance with the second embodiment.

FIG. 9 is a diagram showing a data structure of a prohibition list in accordance with a third embodiment.

### DETAILED DESCRIPTION OF THE INVENTION

The following will describe embodiments of the present disclosure with reference to drawings. The embodiments are mere examples that illustrate the present disclosure. The technical scope of the invention defined in the claims is by no means limited by the following description.

### 1. First Embodiment

### 1.1 Functional Configuration

A description is given first of a first embodiment where the information processing device in accordance with the present disclosure is configured as an image forming apparatus 10. The image forming apparatus 10 is a digital multi-function printer (MFP; multi-function printer/peripheral) that has, for example, a copying function, a printing function, a scanner function, and an email sending function.

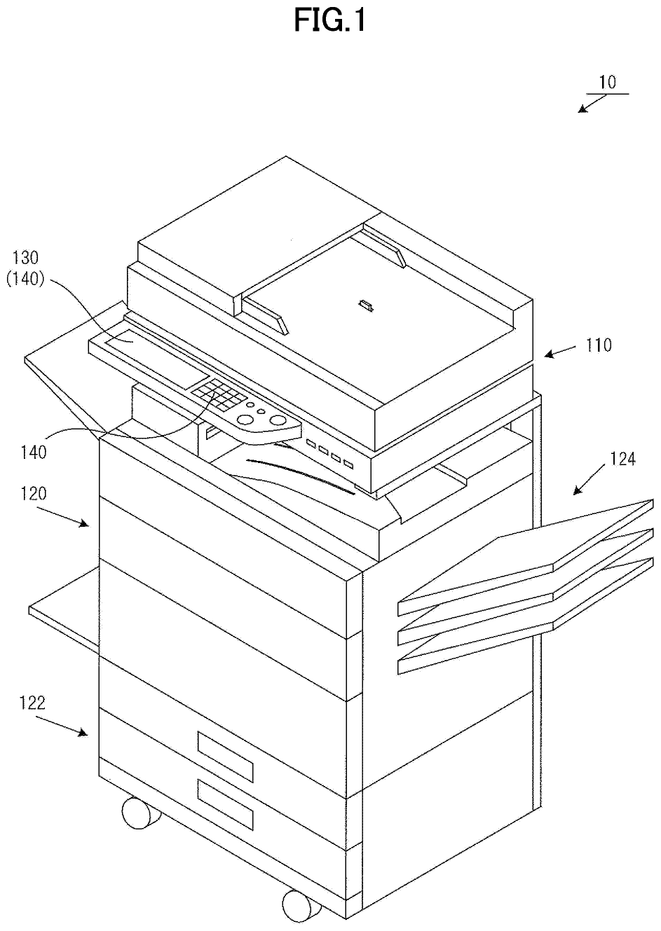

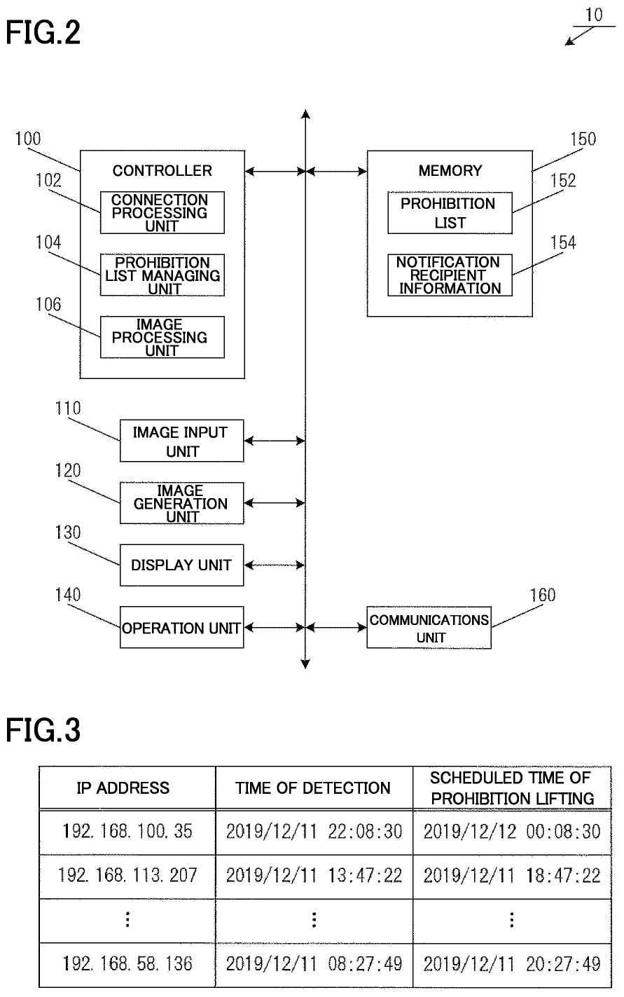

Referring to FIGS. 1 and 2, a description is now given of a functional configuration of the image forming apparatus 10 in accordance with the present embodiment. FIG. 1 is a perspective view of the exterior of the image forming apparatus 10. FIG. 2 is a block diagram of a functional configuration of the image forming apparatus 10. Referring to FIG. 2, the image forming apparatus 10 includes a controller 100, an image input unit 110, an image generation unit 120, a display unit 130, an operation unit 140, a memory 150, and a communications unit 160.

The controller 100 is a functional unit for controlling the entire image forming apparatus 10. The controller 100 retrieves and runs various programs stored in the memory 150 to provide various functions and includes at least one computing device (e.g., CPU (central processing unit)).

The controller 100 runs the programs stored in the memory 150 to serve as a connection processing unit 102, a prohibition list managing unit 104, and an image processing unit 106.

The connection processing unit 102 receives a connection request from an external device via the communications unit 160 and performs a connection process where it is determined whether the received connection request is to be allowed or denied. The connection request received from an external device may be, for example, a TCP (transmission control protocol) SYN packet (TCP-SYN packet). The connection process performed by the connection processing unit 102 will be described later.

The prohibition list managing unit 104 adds information to a prohibition list 152 stored in the memory 150, updates the information in the prohibition list 152, and removes information from the prohibition list 152, to manage the prohibition list 152. In the present embodiment, the prohibition list managing unit 104 performs a prohibition list managing process as a process of managing the prohibition list 152. The prohibition list managing process performed by the prohibition list managing unit 104 will be described later.

The image processing unit 106 performs various processes related to images. For instance, the image processing unit 106 performs an image sharpening process and a gray level conversion process on images captured by the image input unit 110.

The image input unit 110 captures an image of an original document to supply data of the captured image. For instance, the image input unit 110 includes, for example, a scanner unit including CISs (contact image sensors), CCDs (charge coupled devices), or like devices that convert optical information to electric signals, to capture an image of an original document placed on a platen of the image forming apparatus 10. The image input unit 110 may alternatively or additionally include an interface (terminal) for retrieving image data from a storage medium such as a USB (universal serial bus) memory or an SD card. Image data may be supplied from another terminal device via the communications unit 160 capable of connecting to the other terminal device.

The image generation unit 120 forms (prints) an image on a recording medium such as recording paper. The image generation unit 120 includes, for example, an electrophotographic laser printer. The image generation unit 120, for example, feeds recording paper from a paper feeding tray 122 shown in FIG. 1, forms an image on the recording paper, and discharges the recording paper from a paper ejection tray 124.

The display unit 130 displays various information. The display unit 130 includes a display device such as a LCD (liquid crystal display), an organic EL (electro-luminescence) panel, or a micro LED (light-emitting diode) display device.

The operation unit 140 enables a user to operate the image forming apparatus 10. The operation unit 140 includes an input device such as touch sensors. The touch sensors may detect a user input by a resistive, infrared grid, electromagnetic induction, capacitive, or other similarly common detection mechanism. The image forming apparatus 10 may include a touch panel into which the display unit 130 and the operation unit 140 are integrated. The operation unit 140 may include a mouse, a keyboard, and/or any other operating device that enables the user to input information.

The memory 150 stores various programs and data that are necessary for the operation of the image forming apparatus 10. The memory 150 includes, for example, a storage device such as an SSD (solid state drive), which is a semiconductor memory, or a HDD (hard disk drive).

The memory 150 stores the prohibition list 152 and notification recipient information 154. The prohibition list 152 is a list of information on connection sources to which the connection processing unit 102 denies a connection request. The information in the prohibition list 152 includes items each including, for example, an IP (Internet protocol) address (e.g., “192.168.100.35”) that identifies a connection source, a time of detection (e.g., “2019/12/11 22:08:30”), and a scheduled time of prohibition lifting (e.g., “2019/12/12 00:08:30”), as shown in FIG. 3.

The time of detection is the time at which the connection processing unit 102 determines (detects) that a connection from a connection source is risky (annoying). Throughout the present embodiment, the condition(s) on the basis of which the connection processing unit 102 determines that a connection from a connection source is risky is/are referred to as the “detection condition(s).” One of the detection conditions is, for example, that the number of accesses over a prescribed period of time exceeds a preset value (the number of detections) (e.g., 50 accesses in one second). The value may be predetermined or set by the user or manager of the image forming apparatus 10.

The scheduled time of prohibition lifting is a time that comes after the time of detection (e.g., two hours after the time of detection).

In the present embodiment, the prohibition list 152 has a limit on how many connection sources (and related information) the prohibition list 152 can contain therein. As an example, the prohibition list 152 is capable of containing information on up to 50 connection sources. The maximum number of connection sources that the prohibition list 152 can contain may be predetermined or set by the user or manager of the image forming apparatus 10.

The notification recipient information 154 is an address of a recipient of a notification that the prohibition list has been updated. The notification recipient information 154 may be, for example, an email address of the user (manager) who manages the image forming apparatus 10, the IP address of a device used by the user (manager), or an account or password used in user-to-user chat services (exchange of messages).

The communications unit 160 communicates with other devices over a LAN (local area network) or WAN (wide area network). The communications unit 160 includes, for example, a communications device or module, such as NIC (network interface card), used on a wired/wireless LAN.

### 1.2 Process Flow

### 1.2.1 Connection Process

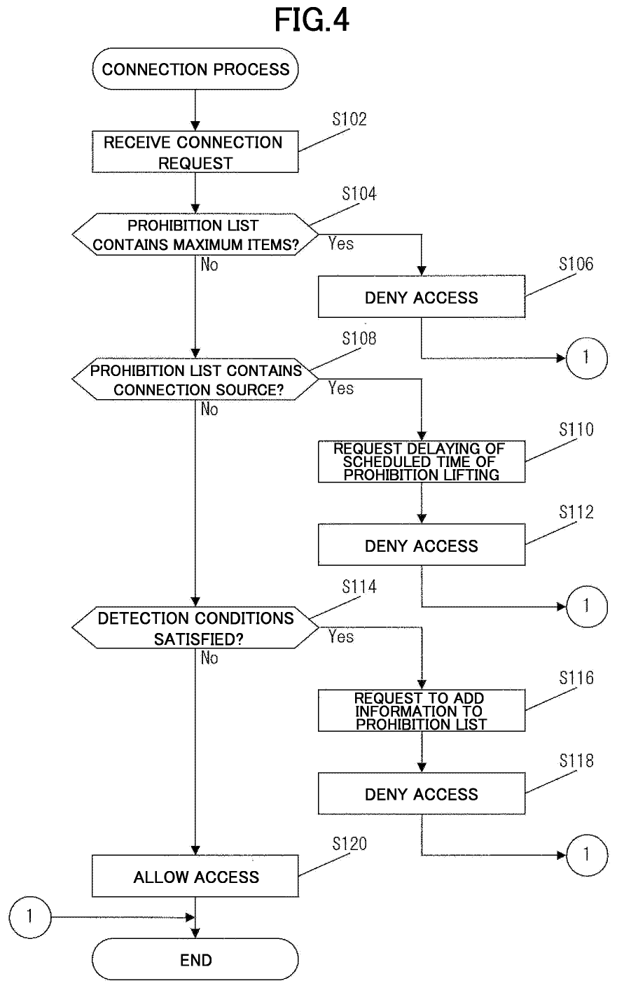

Referring to FIG. 4, a description is given of a flow of a connection process performed by the connection processing unit 102. Assume that the connection processing unit 102 is standing by for a connection request to be sent in from an external device via the communications unit 160.

The connection processing unit 102 first receives a connection request transmitted from an external device via the communications unit 160 (step S102).

The connection processing unit 102 then determines whether or not the prohibition list 152 contains a maximum number of connection sources (step S104). In other words, the connection processing unit 102 determines whether or not the prohibition list 152 can accommodate more connection sources (and related information).

If the prohibition list 152 already contains the maximum number of connection sources (“Yes” in step S104), the connection processing unit 102 denies the connection (access) from the external device (step S106).

For instance, the connection processing unit 102 sends a TCP-RST packet via the communications unit 160 to the connection source that is the device that has sent in a TCP-SYN packet. Thus, the image forming apparatus 10 prohibits reception of the connection request transmitted from the external device (blocks the connection request).

If the prohibition list 152 contains fewer than the maximum number of connection sources (“No” in step S104), the connection processing unit 102 determines whether or not the prohibition list 152 contains information on the device that has sent in the connection request (step S108).

For instance, upon receiving a TCP-SYN packet via the communications unit 160, the connection processing unit 102 acquires the IP address of the device that has sent in the TCP-SYN packet. Then, if the prohibition list 152 contains, in any one of the items of information, the IP address of the device that has sent in the TCP-SYN packet, the connection processing unit 102 determines that the prohibition list 152 contains information on the device that has sent in the connection request.

If the prohibition list 152 contains information on the device that has sent in the connection request (“Yes” in step S108), the connection processing unit 102 requests the prohibition list managing unit 104 to delay the scheduled time of prohibition lifting for the device that has sent in the connection request (step S110).

For instance, the connection processing unit 102 transmits, to the prohibition list managing unit 104, the IP address of the device that has sent in the connection request and an instruction to delay the scheduled time of prohibition lifting for the device. The connection processing unit 102 may store, in the memory 150, information necessary to delay the scheduled time of prohibition lifting (e.g., the IP address of the device that has sent in the connection request and a flag indicating that the scheduled time of prohibition lifting for the device needs to be delayed).

Subsequently, the connection processing unit 102 denies the connection (access) from the external device (step S112). Step S112 is essentially the same as step S106.

If it is determined in step S108 that the prohibition list 152 does not contain information on the device that has sent in the connection request (“No” in step S108), the connection processing unit 102 determines whether or not the detection conditions are satisfied (step S114).

For instance, the connection processing unit 102 counts a reception of a TCP connection request (TCP-SYN packet) as one access and acquires the number of accesses over a prescribed period of time (e.g., one second). If the number of accesses over that the prescribed period of time is greater than or equal to a preset value, the connection processing unit 102 determines that the detection conditions are satisfied.

If the detection conditions are satisfied (“Yes” in step S114), the connection processing unit 102 requests the prohibition list managing unit 104 to add information on the device that has sent in the connection request to the prohibition list 152 (step S116).

For instance, the connection processing unit 102 transmits, to the prohibition list managing unit 104, the IP address of the device that has sent in the connection request and an instruction to add information on the device to the prohibition list 152. The connection processing unit 102 may store, in the memory 150, information necessary to add information on the device that has sent in the connection request to the prohibition list 152 (e.g., the IP address of the device that has sent in the connection request and a flag indicating that information needs to be added to the prohibition list 152).

Subsequently, the connection processing unit 102 denies the connection (access) from the external device (step S118). Step S118 is essentially the same as step S106.

If it is determined in step S114 that the detection conditions are not satisfied (“No” in step S114), the connection processing unit 102 allows the connection (access) from the external device (step S120).

For instance, the connection processing unit 102 transmits a TCP-SYN/ACK packet via the communications unit 160 to the device that has sent in the connection request.

### 1.2.2 Prohibition List Managing Process

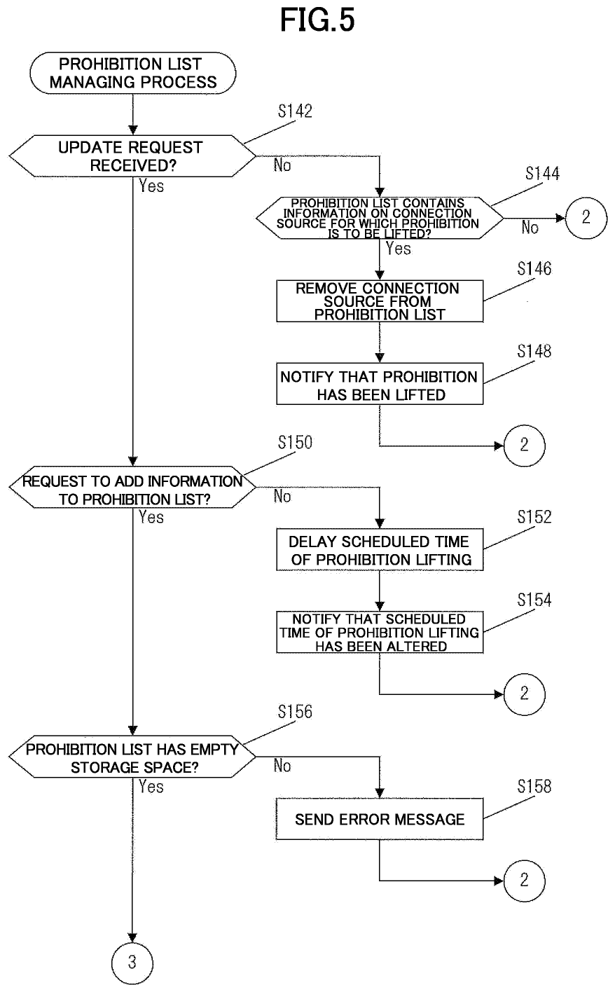

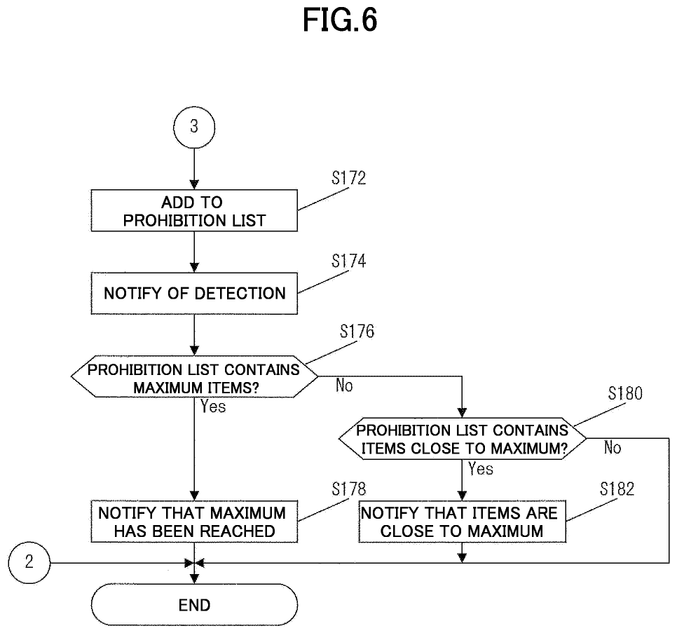

Referring to FIGS. 5 and 6, a description is given next of a flow of a prohibition list managing process performed by the prohibition list managing unit 104. The prohibition list managing unit 104 performs a prohibition list managing process at a prescribed timing (e.g., every one second) or in response to an instruction issued by the connection processing unit 102 in steps S110 and S116 in the connection process.

The part of the process shown in FIG. 5 is first described. The prohibition list managing unit 104 determines whether or not there has been a request to update information in the prohibition list 152 (update request) (step S142). Upon receiving from the connection processing unit 102, for example, an instruction to delay the scheduled time of prohibition lifting or an instruction to add information on the device that has sent in the connection request to the prohibition list 152, the prohibition list managing unit 104 determines that there has been an update request. The prohibition list managing unit 104 may determine that there has been an update request if the memory 150 contains information representing that the scheduled time of prohibition lifting needs to be delayed or information for adding information on the device that has sent in the connection request to the prohibition list 152.

If there has been no update request (“No” in step S142), the prohibition list managing unit 104 determines whether or not the prohibition list 152 contains information on the connection source for which connection prohibition needs to be lifted (step S144).

For instance, the prohibition list managing unit 104 retrieves, from the prohibition list 152, those items for which the listed scheduled time of prohibition lifting has passed. If the prohibition list managing unit 104 has retrieved any such an item, the prohibition list managing unit 104 determines that the prohibition list 152 contains information on the connection source(s) for which connection prohibition needs to be lifted.

If the prohibition list 152 contains information on the connection source(s) for which connection prohibition needs to be lifted (“Yes” in step S144), the prohibition list managing unit 104 removes, from the prohibition list 152, the item(s) containing information on the connection source(s) for which connection prohibition needs to be lifted (step S146).

The prohibition list managing unit 104 further sends a notification that prohibition has been lifted for the connection source(s) in the prohibition list 152 (step S148). The notification includes, for example, the IP address for which prohibition has been lifted and the times of detection and prohibition lifting for the IP address. The “time of prohibition lifting” refers to the time when step S146 is performed. The prohibition list managing unit 104 sends the notification by means of an email or a message on the basis of a notification recipient contained in the notification recipient information 154 stored in the memory 150.

If it is determined in step S144 that the prohibition list 152 does not contain information on the connection source for which connection prohibition needs to be lifted (“No” in step S144), the prohibition list managing unit 104 terminates the prohibition list managing process.

If it is determined in step S142 that three has been an update request (“Yes” in step S142), the prohibition list managing unit 104 determines whether or not this update request is a request to add information on a connection source to the prohibition list 152 (step S150).

If the update request is not a request to add information on a connection source (“No” in step S150), it follows that the update request is a request to delay a scheduled time of prohibition lifting. In such cases, the prohibition list managing unit 104 delays the scheduled time of prohibition lifting in response to the request to delay the scheduled time of prohibition lifting (step S152).

For instance, the prohibition list managing unit 104 acquires the IP address contained in the instruction from the connection processing unit 102 and the IP address stored together with a flag indicating that the scheduled time of prohibition lifting needs to be delayed in the memory 150. Subsequently, the prohibition list managing unit 104 retrieves, from the prohibition list 152, the item containing the acquired IP address. The prohibition list managing unit 104 then updates the scheduled time of prohibition lifting in the retrieved item by a prescribed length of time (e.g., 1 minute) and stores the updated time as the scheduled time of prohibition lifting. In other words, the prohibition list managing unit 104 delays the scheduled time of prohibition lifting for the connection-prohibited connection source. The length of time by which the scheduled time of prohibition lifting is delayed may be predetermined or set by the user or manager of the image forming apparatus 10.

The prohibition list managing unit 104 sends a notification that the scheduled time of prohibition lifting has been delayed in the prohibition list 152 (step S154). This notification includes, for example, the IP address of the connection source for which the scheduled time of prohibition lifting has been delayed, the time of detection and the updated scheduled time of prohibition lifting for the IP address. The prohibition list managing unit 104 sends the notification in practically the same manner as in step S148.

If it is determined in step S150 that the update request is a request to add information on the connection source to the prohibition list 152 (“Yes” in step S150), the prohibition list managing unit 104 determines whether or not the prohibition list 152 has empty storage space (step S156).

For instance, if the number of connection sources in the prohibition list 152 is less than or equal to the maximum number of connection sources that the prohibition list 152 can contain, the prohibition list managing unit 104 determines that the prohibition list 152 has empty storage space.

If the prohibition list 152 has no empty storage space (“No” in step S156), it indicates that there must be some contradiction in the process performed by the controller 100. In such cases, the prohibition list managing unit 104 does not update the prohibition list 152 and sends, to the functional unit from which an instruction has been received to perform the prohibition list managing process (e.g., the controller 100 or the connection processing unit 102), a response that there has occurred an error (step S158). The functional unit, upon receiving the error response, performs a prescribed process.

Referring to FIG. 6, a description is given next of a process performed by the prohibition list managing unit 104 when the prohibition list 152 has empty storage space in step S156. The prohibition list managing unit 104 adds information on the connection source to the prohibition list 152 in response to a request to add information on the connection source to the prohibition list 152 (“Yes” in step S156 and on to step S172).

For instance, the prohibition list managing unit 104 acquires the IP address contained in the instruction from the connection processing unit 102 and the IP address stored together with a flag indicating that information needs to be added to the prohibition list 152 in the memory 150. Subsequently, the prohibition list managing unit 104 adds, to the prohibition list 152, an item containing the acquired the IP addresses, the current time as the time of detection, and the time that is calculated as the scheduled time of prohibition lifting by adding a prescribed length of time (e.g., 3 hours) to the time of detection. The length of time added to the time of detection may be predetermined or set by the user or manager of the image forming apparatus 10.

The length of time added to the time of detection may also be altered in accordance with the country and/or network of the connection source. For instance, the prohibition list managing unit 104 may reduce the length of time added to the time of detection if the connection source is in the local country or segment as the image forming apparatus 10 and increase the length of time added to the time of detection if the connection source is not in the local country or segment as the image forming apparatus 10. The length of time added to the time of detection may be altered in accordance with the number of accesses. For instance, the prohibition list managing unit 104 may increase the length of time added to the time of detection in accordance with an increase in the number of accesses received before it is prohibited to accept the connection request.

The prohibition list managing unit 104 further sends a notification that a connection has been detected that satisfies the detection conditions (step S174). This notification includes, for example, the detected IP address, the time of detection, and the scheduled time of prohibition lifting. The prohibition list managing unit 104 sends the notification in practically the same manner as in step S148.

Subsequently, the prohibition list managing unit 104 determines whether or not the number of connection sources in the prohibition list 152 has reached the maximum (whether or not the list is full) (step S176). If the prohibition list 152 is full, the prohibition list managing unit 104 sends a notification that the number of connection sources in the prohibition list 152 has reached the maximum (step S178). The prohibition list managing unit 104 sends the notification in practically the same manner as in step S148.

On the other hand, if the number of connection sources in the prohibition list 152 is less than the maximum (“No” in step S176), the prohibition list managing unit 104 determines whether or not the number of connection sources in the prohibition list 152 is close to the maximum (whether or not the list is almost full) (step S180).

For instance, if the number of connection sources that can be added to the prohibition list 152 is smaller than or equal to a predetermined number (reference value), the prohibition list managing unit 104 determines that the number of connection sources in the prohibition list 152 is close to the maximum. The reference value may be an absolute number or a number determined from a ratio to the number of connection sources that can be contained in the prohibition list 152. The reference value may be predetermined or set by the user or manager of the image forming apparatus 10.

In this example, if the number of connection sources that can be added to the prohibition list 152 is less than or equal to the reference value, the prohibition list managing unit 104 determines that the number of connection sources in the prohibition list 152 is close to the maximum (“Yes” in step S180). The prohibition list managing unit 104 then sends a notification that the number of connection sources in the prohibition list 152 is close to the maximum (step S182). The prohibition list managing unit 104 sends the notification in practically the same manner as in step S148.

On the other hand, if the prohibition list managing unit 104 determines in step S180 that the number of connection sources in the prohibition list 152 is not close to the maximum, the prohibition list managing unit 104 terminates the prohibition list managing process (“No” in step S180).

Whether the prohibition list managing unit 104 sends a notification based on the condition of the prohibition list 152 or not may be set by the user who receives the notification (e.g., the manager of the image forming apparatus 10). The setting as to whether a notification should be sent may be made uniformly for all notifications or separately for each notification. If all or any notifications are denied, the prohibition list managing unit 104 skips (omits) steps S148, S154, S174, S178, and/or S182 in the above-described processes in accordance with the type(s) of the denied notifications.

The foregoing description mentions in relation to step S172 that the time of detection contained in the prohibition list 152 is the time when the information on the connection source is stored in the prohibition list 152. This time of detection may alternatively be the time when the detection conditions are satisfied, in which case the connection processing unit 102 renders the time when the detection conditions are satisfied available to the prohibition list managing unit 104.

In the present embodiment, the image forming apparatus can increase the length of time over which accesses are prohibited for connection sources that make frequent attempts to access the image forming apparatus (send frequent connection requests to the image forming apparatus) (highly risky or annoying connection sources). Meanwhile, the image forming apparatus can reduce the length of time over which accesses are prohibited for connection sources that make only one attempt or very few attempts to access the image forming apparatus (hardly risky or annoying connection sources). The present embodiment thus enables flexible setting of the length of time over which connection requests are denied in accordance with risk and/or annoyance.

In addition, the present embodiment enables setting of a maximum number of connection sources in the prohibition list. The present embodiment can remove information on a connection source from the prohibition list in accordance with the transmission of connection requests from the connection source and can increase the length of time over which the prohibition list contains information on the connection source by delaying the scheduled time of prohibition lifting in accordance with the transmission of connection requests from the connection source. The present embodiment thus caps the number of connection sources in the prohibition list and manages information on the connection sources in the prohibition list in a suitable manner, thereby enabling the image forming apparatus to save the storage space of the memory or like storage device. Additionally, since the maximum number of connection sources in the prohibition list is specified, the image forming apparatus can reduce the resources (CPU workload and required time for collation/checking) required to check whether a connection request should be allowed or denied.

### 2. Second Embodiment

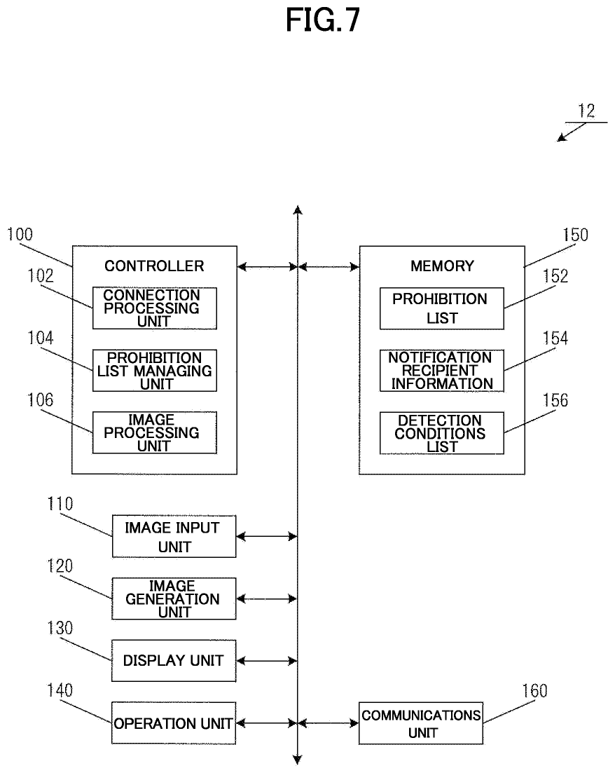

The following will describe a second embodiment that differs from the first embodiment in that in the second embodiment, characteristics of the connection source that has sent in a connection request are acquired and the detection conditions are altered on the basis of these characteristics. Reference should be made to the same set of drawings in the present embodiment as in the first embodiment, except that FIG. 2 is replaced by FIG. 7. The same reference numerals in the drawings denote identical functional units or processes, and their description is omitted.

Referring to FIG. 7, a description is given of a functional configuration of an image forming apparatus 12 in accordance with the present embodiment. The image forming apparatus 12 differs from the image forming apparatus 10 in accordance with the first embodiment in that in the former, the memory 150 further stores a detection conditions list 156.

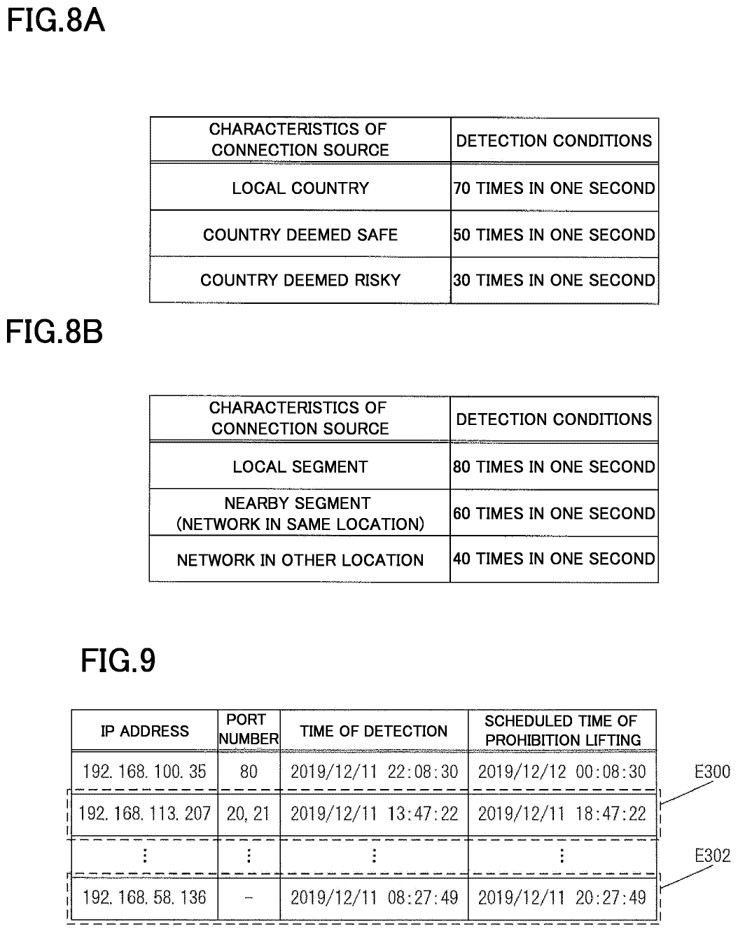

The detection conditions list 156 is a list of characteristics of connection sources and the detection conditions that match the characteristics. Each item in the detection conditions list 156 includes, for example, characteristics of the connection source (e.g., “local country”) and the detection conditions that match the characteristics (e.g., 70 times in one second) as shown in FIGS. 8A-8B.

FIGS. 8A-8B are a set of diagrams each showing a concrete example of the detection conditions list 156. FIG. 8A is an example of the detection conditions list 156 where the detection conditions differ with the country of the connection source. Referring to FIG. 8A, for example, the detection conditions are set to “70 times in one second” if the connection source is in the local country, “50 times in one second” if the connection source is deemed in a safe country, and “30 times in one second” if the connection source is deemed in a risky country.

In this example, the connection processing unit 102 performs the following process in step S114 in the connection process shown in FIG. 4.

### (1) Acquiring Country of Connection Source

The connection processing unit 102 acquires the country to which the device that has sent in a connection request belong on the basis of, for example, the contents of the connection request. For instance, the connection processing unit 102 acquires the IP address of the sender of the connection request to acquire the country to which the IP address is assigned.

### (2) Acquiring Detection Conditions

The connection processing unit 102 determines whether the acquired country is the local country, a country deemed safe, or a country deemed risky and acquires the detection conditions that match the result.

The memory 150 may store in advance information on countries including those deemed safe and those deemed risky. Alternatively, the user may make settings on such information. The memory 150 may store, in the form of history, the countries for which connection requests were previously denied and the date and time when the connection requests were denied, so that the controller 100 can automatically designate countries deemed safe and countries deemed risky on the basis of the history. For instance, the controller 100 may designate a country as a country deemed risky if the number of times a connection request was denied in a prescribed period (e.g., in the last one month period) is greater than or equal to a prescribed threshold value (e.g., 5 times) and designate a country as a country deemed safe if that number is smaller than the prescribed threshold value.

### (3) Determining Whether Detection Conditions are Satisfied

The connection processing unit 102 determines whether or not a connection from the connection source is risky on the basis of the detection conditions acquired in (2).

FIG. 8B is an example of the detection conditions list 156 where the detection conditions differ with the segment of the network to which the connection source belong. Referring to FIG. 8B, for example, the detection conditions are set to “80 times in one second” if the device of the connection source belongs to the same segment as the image forming apparatus 10, “60 times in one second” if the device of the connection source belongs to the same location (nearby segment (network in the same location)) as the image forming apparatus 10, and “40 times in one second” if the device of the connection source belongs to a different location (network in another location) than the image forming apparatus 10.

In this example, the connection processing unit 102 likewise acquires the segment of the connection source as in (1) above, acquires detection conditions as in (2) above, and determines whether or not the detection conditions are satisfied as in (3) above, in step S114 in the connection process shown in FIG. 4.

The present embodiment enables the user to make the detection conditions stringent or mild in accordance with the characteristics of the connection source, so that the image forming apparatus can control accesses in accordance with connection requests in a suitable manner.

### 3. Third Embodiment

The following will describe a third embodiment that differs from the first embodiment in that in the third embodiment, the image forming apparatus 10 can control whether to allow or deny a connection request in view of information other than the IP address.

FIG. 9 is a diagram showing an example of a prohibition list 152 in accordance with the present embodiment. The prohibition list 152 in accordance with the present embodiment differs from the prohibition list 152 in accordance with the first embodiment shown in FIG. 3 in that the former additionally contains port numbers.

For instance, the item denoted by E300 in FIG. 9 indicates that a connection request is denied for the IP address “192.168.113.207” and the port number “20,21.” A connection request may be denied for an item with the IP address “192.168.58.136” regardless of the port number thereof, as is the case for the item denoted by E302 in FIG. 9.

The prohibition list 152 contains both IP addresses and port numbers in the present embodiment as described here. The connection processing unit 102 can thus determine whether to allow or deny a connection request on the basis of the combination of an IP address and a port number.

The prohibition list 152 in accordance with the present embodiment does not necessarily have the format that provides both IP addresses and port numbers as shown in FIG. 9. In other words, the information used in determining whether to allow or deny a connection request is not necessarily a combination of an IP address and a port number.

For instance, to directly connect the image forming apparatus 10 to another apparatus or device, a MAC (media access control) address may be used as the information used in determining whether to allow or deny a connection request.

In a request to add information to the prohibition list 152 in step S116 in the connection process shown in FIG. 4, the connection processing unit 102 in accordance with the present embodiment includes information such as the IP address of the connection source device and the port number being used. In this example, what information is to be included in a request to add to the prohibition list 152 may be predetermined or determined on the basis of the connection requests in which the detection conditions are satisfied.

As an example of operation in the present embodiment, for example, the image forming apparatus 10 that is equipped with a Web server can be switchably set to allow or deny a connection request if the image forming apparatus 10 can be set up on a page provided by the Web server. For instance, if a device is making frequent connection requests to the image forming apparatus 10 for a page, the connection processing unit 102 denies connection requests from the IP address and port number contained in the connection requests. In this example, if the port number contained in a connection request for a page differs from the port number contained in a connection request for a transfer of print data, the image forming apparatus 10 does not deny the connection request for a transfer of print data. Therefore, the device for which the image forming apparatus 10 has denied a connection request for a page is still allowed to transfer print data to the image forming apparatus 10 (e.g., via a printer driver).

The present embodiment hence enables the image forming apparatus to control in a flexible manner whether to allow or deny a connection request from another apparatus or device.

### 4. Fourth Embodiment

The following will describe a fourth embodiment where the information processing device in accordance with the present disclosure is built around a device other than an image forming apparatus. The device that controls whether to allow or deny a connection request may be, for example, an information processing device such as a PC (personal computer) or server, a smartphone, or a tablet computer or an “IoT” (Internet of things) device.

No matter into which category the device falls, the controller of the device needs only to be able to perform the processes that are carried out by the connection processing unit 102 and the prohibition list managing unit 104 in the first to third embodiments. This particular configuration enables various devices to, for example, deny a connection request from another device for a prescribed length of time or automatically deny the connection request in accordance with the number of accesses.

### 5. Variation Examples

The present invention is not limited to the description of the embodiments above and may be altered within the scope of the claims. Embodiments based on a proper combination of technical means disclosed in different embodiments are encompassed in the technical scope of the present invention.

The embodiments are at least partially described separately for convenience of description, but may be unarguably combined in reducing the invention into practice as long as it is technically feasible to do so. For instance, by combining the second embodiment and the third embodiment, the image forming apparatus can both alter the detection conditions in accordance with the information on the sender of a connection request and control whether to allow or deny a connection request in accordance with a connection request.

The programs run on the apparatus or device in each embodiment above control, for example, the CPU to provide the functions of the embodiment (programs enabling a computer to function). The information handled by these devices are temporarily stored in a temporary storage device (e.g., RAM) during the process, then stored in one of various storage device such as a ROM (read-only memory) or a HDD, and where necessary, retrieved, edited, and written back by the CPU.

The programs may be stored in a storage medium such as a semiconductor medium (e.g., a ROM or a non-volatile memory card), an optical or magneto-optical storage medium (e.g., a DVD (digital versatile disc), an MO (magneto optical disc), an MD (mini disc), a CD (compact disc), or a BD (Blu-ray® disk)), or a magnetic storage medium (e.g., a magnetic tape, or a flexible disk). Loading and running the programs not only provides the functions of the embodiments described above, but in some cases also provides the functions of an embodiment of the present invention if the programs are run along with an operating system or other program that run on the basis of instructions from the programs.

For distribution on the market, the programs may be contained in a portable storage medium or transferred to a server computer connected over a network such as the Internet, in which case the scope of the present invention unarguably encompasses the storage device in the server computer.

What is claimed is:

1. An information processing device comprising:
a memory that stores, in an associated manner, information on a connection source and a time when denial of a connection request from the connection source is to be lifted; and
a controller that, upon receiving a connection request from the connection source, denies the connection request based on the information stored in the memory, wherein
the controller removes the information on the connection source from the memory when the time has passed.

2. The information processing device according to claim 1, wherein upon receiving a connection request from the connection source for which a connection request is denied, the controller delays the time when denial of a connection request from the connection source is to be lifted.

3. The information processing device according to claim 1, wherein upon receiving a connection request from a connection source with a frequency that satisfies a detection condition, the controller stores the connection source and a time when denial of a connection request from the connection source is to be lifted in the memory in an associated manner.

4. The information processing device according to claim 3, wherein the controller alters the detection condition in accordance with the connection source.

5. The information processing device according to claim 1, wherein the information on the connection source includes at least any one of an IP (internet protocol) address, a MAC (media access control) address, and a port number or a combination thereof.

6. A control method comprising:
the storing step of storing, in an associated manner, information on a connection source and a time when denial of a connection request from the connection source is to be lifted;
the denial step of, upon receiving a connection request from the connection source, denying the connection request based on the information stored in the storing step; and
the removal step of removing the information on the connection source when the time has passed.
